(19) United States
(12) Patent Application Publication
(10) Pub. No.: US 2006/0202469 A1
(43) Pub. Date: Sep. 14, 2006

(54) Financial instrument having indicia related to a security feature thereon

(76) Inventor: Neil Teitelbaum, Ottawa (CA)

Correspondence Address: TEITELBAUM & MACLEAN, 1187 BANK STREET, SUITE 201, OTTAWA, ON, K1S 3X7, CA

(21) Appl. No.: 11/075,657

(22) Filed: Mar. 10, 2005

(51) Int. Cl. B42D 15/00

(52) U.S. Cl. 283/72

(57) ABSTRACT

A financial instrument such as a banknote includes a substrate and a security authenticating device on the substrate, such as a visual or tactile security feature. To allow a holder of the banknote to authenticate the instrument, indicia is provided supported by the substrate for indicating the functionality of the visual or tactile feature. The indicia is reproducible by a photographic process, however the security feature is not reproducible in this manner. The indicia may include a legend at a first location bearing information related to one or more security features. Corresponding security feature location indicators are provided at other locations where the one or more security features are present. This essentially provides symbolic instructions on the banknote as to its security features.

### FIELD OF THE INVENTION

This invention relates to an article having a security device and having one or more symbols or indicia that can be copied for identifying and authenticating the security device.

### BACKGROUND OF THE INVENTION

Various techniques have been employed over the years to discourage use of conventional office equipment (e.g., color photocopiers) for counterfeiting of banknotes and similar financial instruments. One technique is to equip photocopiers with the capability to recognize banknotes documents and, upon such recognition, disable or impair copying. The term financial instruments as used in this specification includes banknotes, credit/debit instruments and other forms of valuable instruments which require authentication.

While such approaches offer some deterrence against counterfeiting, they suffer from various drawbacks and limitations. The present invention seeks, through its various embodiments, to redress certain of these drawbacks and to provide additional functionality not previously available.

As of late, many banknotes carry security features such as security thread, security labels and regions within the notes which, for example, change color with angle of incident light or with viewing angle. Alternatively text or symbols may be offset from the banknote to be in relief. Embossing is used in banknotes for example to provide regions having Braille; and, ghosting, holograms and other security features difficult or impossible to copy with conventional copying machines are used. There are numerous patents teaching different security devices based on color shifting pigments and foils. For example U.S. Pat. No. 6,841,238 in the name of Argoitia et al., assigned to Flex Products Inc. teaches of chromatic diffractive pigments and foils; U.S. Pat. No. 6,838,166 in the name of Phillips et al., assigned to Flex Products Inc teaches Multi-layered magnetic pigments and foils; U.S. Pat. No. 6,833,959 assigned to Flex Products Inc teaches Color shifting carbon-containing interference pigments.

As of late, banknotes typically have a plurality of distinct features on a single banknote in an attempt to make copying more difficult. Furthermore, more complex features are being utilized. For example some pigment flakes having color shifting properties also have diffractive grooves within the flakes which allow them to be aligned when subjected to a magnetic field. By using such complex pigments, features such a changing rolling bar, images having only predetermined portions which change color or contrast when tilted or rotated, and other difficult to copy features are practicable.

Authenticating banknotes having such features as color shifting films has been done visually and by machine. By using a machine, dedicated to authenticate a particular currency, the machine can be programmed to determine if certain preprogrammed features are present. This does not require a skilled user or operator and does not even require the operator to know which features are supposed to be present in the currency being authenticated. The machine simply provides a binary type of authentication to the user. For example U.S. Pat. No. 6,473,165 assigned to Flex Products in the name of Coombs et al. describes an automated verification system for authenticating an object having an optical security feature. The analyzing device receives the light beams reflected or transmitted from the object and is adapted to analyze the optical characteristics of the light beams at varying angles and/or wavelengths to verify the authenticity of the object.

Although the device and method taught by Coombs et al. offers a high degree of reliability and sensitivity when authenticating currency, it would also be beneficial to have a way in which to offer most people carrying currency to perform some form of visual authentication without the requirement of a complex testing machine.

Since people are equipped with visual and tactile acuity, but only a limited memory to remember particular features present on currency, this invention provides a means to utilize one's visual and tactile abilities.

In instances where one has no a priori knowledge of the features on a currency, this invention assists in the authentication process by providing textual or symbolic indicators or instructions as to the location and features present.

Governments are currently investing in educating the public as to the presence of important identifiable security features on currency. However, this requires those educated to remember which features are on which currency and these features often vary between different denominations of a same currency. As a result, a great number of people simply don't know what they should be looking for when visually inspecting a bank note. If for example a government is successful in educating a large percentage of its citizens as to the expected features that should be present on a particular currency, these features change over time as new issues are circulated, and retraining is required. Furthermore, if for example a currency of one country is circulated in foreign country, it would be difficult to educate citizens of that foreign country as to which features are present on the banknotes.

By way of example many people are not aware that a color shifting region should change color with incident angle or angle of viewing. Furthermore, many people who are aware that color shifting features are present are not aware of what color the optically variable coating should shift to. By way of example, the shift could be from red to blue, or from green to gold.

There are now currencies which have a filter which serves as tool in the form of a substantially transparent window built into a portion of the banknote which is to be placed over another region of the note, so that a security feature appears when the filter is correctly placed over the target. However, one problem is, users of the currency require knowledge of these features.

As security features, especially on banknotes and financial instruments become more and more complex, it will become increasingly difficult for the public to remember which features are supposed to be present on such an instrument.

It is an object of this invention to provide indicia separate from, but related to the feature present on a security device which will educate the user as to function of the feature.

It is an object of this invention to provide a means related to the color shift coating for comparison so that a user can compare this to the color shift coating.

It is a further object of the invention to provide a instructive region or indicia indicating that a color shifting region is, in fact a color shifting region.

It is a further object of this invention to provide on a banknote additional information relating to a feature on the banknote which effectively instructs a user as to a characteristic of the feature.

For example it is an object of the invention to provide a user with indicia on or near a color shift region effectively indicating that the color shift region changes color.

By providing indicia on or near a color shift region, indicating its function, a user can discern a banknote that was photocopied by comparing the indicia with the performance of the color shift region. Since photocopied banknote will not shift in color but the indicia indicates that a shift is expected, the holder of the note will know that the note is likely not authentic.

### SUMMARY OF THE INVENTION

In accordance with the invention there is provided an article having a security authenticating device thereon, wherein a functional feature associated with the security device is a visual or tactile feature, and wherein the feature cannot be copied by a photographic process; and, indicia on the article indicating the functionality of the feature associated with the security device, wherein the indicia can be copied by a photographic process, including photocopying, digital reproduction, and conventional photographic processes such as copying using a camera.

In accordance with the invention, there is provided, a device having therein or thereon a security feature in the form of a color shift region that exhibits a color shift with change of viewing angle or angle of incidence of light directed upon it, and indicia in addition to the security feature, on or near the color shift region that indicates that the color shift region shifts colors.

In accordance with the invention in a article having a color shifting region; and, a region separate from the color shifting region that indicates at least ends of a range of colors related to the color shifting region in the form of a symbolic legend for providing a comparison of the color shift of the color shift region with the symbolic legend to verify the authenticity of the article.

In accordance with this invention, there is provided a financial instrument having therein or thereon security feature which serves to identify the instrument, and indicia in the form of one or more symbols which correspond to the function of the security feature so that a holder of the currency can use the one or more symbols to identify and authenticate the security feature.

In accordance with the invention, an article is provided comprising:

a substrate;

a security authenticating device on the substrate, including a visual or tactile security feature; and,

indicia supported by the substrate for indicating the functionality of the visual or tactile feature, wherein the indicia is reproducible by a photographic process, wherein said indicia includes a legend at a first location bearing information related to one or more security features and corresponding security feature location indicators at other locations where the one or more security features are present. The abovementioned article may be a financial instrument such as a banknote.

### BRIEF DESCRIPTION OF THE DRAWINGS

Exemplary embodiments of the invention will now be described in accordance with the drawings in which:

FIG. 1 is a plan view of a paired optically variable article incorporating paired optically variable structures in accordance with the prior art (Phillips U.S. Pat. No. 5,766,738)

FIG. 2 is a cross-sectional view taken along the line 2-2 of FIG. 1.

FIG. 3a is a plan view of a paired optically variable article incorporating the present invention in which a symbol is incorporated therein and is not visible to the human eye at a predetermined angle of incidence.

FIG. 3b is a plan view similar to FIG. 3a but viewed at a different angle of incidence which makes visible the “SICPA” symbol incorporated in the paired optically variable article.

FIG. 4 is a cross-sectional view taken along the line 20-20 in FIG. 3b.

FIG. 5 is a plan view of a 100 dollar Canadian banknote having a security label on the upper left corner.

FIG. 6 is a plan view of the banknote shown in FIG. 5 having text next to the security label indicating the approximate location and feature provided by the security label.

FIG. 7 is a plan view of the banknote shown in FIG. 5 having text and a symbol indicating next to the security label indicating the approximate location and feature provided by the security label, wherein the symbol <-> indicates color shifting.

FIG. 8 is a plan view of a recently issued fifty dollar Canadian banknote having a plurality of security features.

FIG. 9 is a plan view of the banknote shown in FIG. 8, having a legend at the lower edge of the bill, indicating the features and approximate location present on the banknote.

FIG. 10 is a plan view of the banknote shown in FIG. 8, having a legend at the upper edge of the bill, indicating the features present on the banknote wherein numerals on the banknote indicate the location.

FIG. 11 is a plan view of a portion of a banknote having two regions with symbols indicating the approximate location and function provided by security features present.

### DETAILED DESCRIPTION

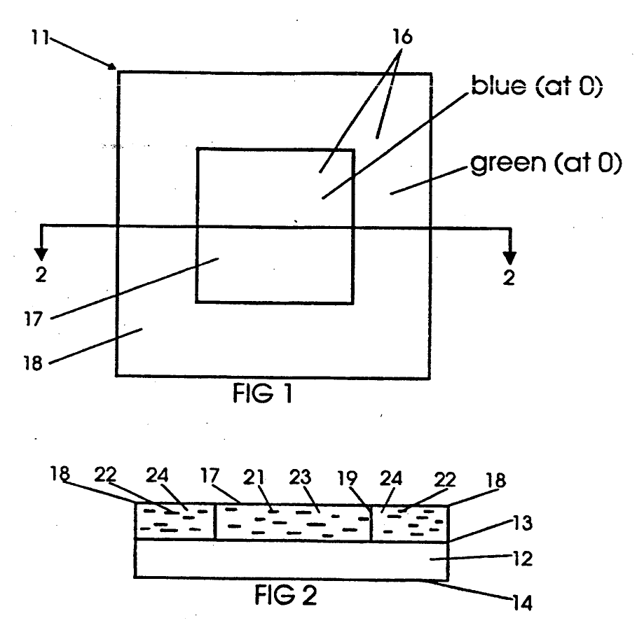

Various security features can be provided on bank notes or devices requiring security features that allow authentication. The optically variable article shown in prior art FIG. 1 originally described by Phillips in U.S. Pat. No. 5,766,738 incorporated herein by reference is for use or viewing under incident light and is comprised of a substrate having first and second surfaces. First and second optical structures are carried by the first surface of the substrate in first and second spaced apart portions on the first surface to permit viewing at the same time by a human eye. A first optically variable pigment is disposed in the first optical structures and a second optical pigment is disposed in the second optical structure. The first and second optical structures have substantially the same color at one angle of incidence and colors different from each other at all other angles of incidence.

More in particular as shown in FIG. 1 of the drawings, the optically variable article 11 consists of a substrate 12 provided with first and upper surface 13 and a second or lower surface 14 as shown in FIG. 2. The substrate 12 can be flexible or rigid and can be formed of any suitable material such as paper, plastic, cardboard, metal and the like. Ideally, this security feature can be disposed on a banknote. The substrate 12 can be opaque or transparent. Paired optically variable structures 16 in a polymeric binder are disposed on one of the surfaces as for example on the first or top surface 13 as shown in FIG. 2 so that they are not superposed but are lying in spaces which are physically separated from each other on the plane of the surface 13. When the optically variable article is viewed the paired optically variable structures 16 can be viewed simultaneously.

Thus as shown in FIG. 1, the device 11 has paired optically variable structures 16 provided in a first optically variable structure or pattern 17 and also in a second optically variable structure or pattern 18. The first and second structures 17 and 16 do not overlap and are spaced apart but are disposed adjacent to each other and as shown in FIG. 2 in an abutting relationship. The first structure 17 is in the form of a rectangle or square and is disposed within a recess 19 formed by the second structure 16 also being in the form of a rectangle or square to form a border or frame that surrounds the first structure 17.

The first optically variable structure is provided with a first pigment formed of optically variable flakes 21 constructed in the manner hereinbefore described to provide a first color shift with angle. The second optically variable structure 18 is provided with a second pigment formed of optically variable flakes 22 also constructed in the manner hereinafter described and providing a second color shift with angle. As shown in FIG. 2, the pigments 21 and 22 are disposed of in solidified liquid vehicles 23 and 24 respectively of a conventional type so that the optically variable structures 17 and 18 can have the desired characteristics. For example if an ink is the resulting product, a conventional ink vehicle is utilized whereas if a paint is the desired product, a paint vehicle of a suitable type is utilized.

In the first and second pigments or flakes 21 and 22 utilized, it is important that the two pigments have the same color at one angle of incidence of light and have different colors at all other angles of incidence of light. Thus by way of example, the pigments 21 and 22 can be constructed so that at a 10 degree angle of incidence of light, the two pigments have the same color but at any other higher angle of incidence the two optically variable pigments 21 and 22 will have different colors which for example at 45 degree are markedly different. Conversely, the pigments 21 and 22 could be constructed so that they have the same color at a different angle as for example an angle of 45 degree but have different colors at all other angles of incidence. However, it should be understood that other color matches can be found from 0 degree-90 degree. Thus by way of example with the device 11 shown in FIG. 1, the pigments 21 and 22 at an angle of incidence of about 10 degree would have the same color or a matched color, as for example, green an another color, magenta at another angle of about 45 degree for the first device 17 and the color blue for the second device 18. Thus, it can be seen there is a dramatic color shift differential when shifting from 10 degree to 45 degree the angle of incidence of the paired optically variable device 11.

In one embodiment of the invention as shown in FIG. 1, the inner first optically variable structure (OVD) 17 had the following characteristics with respect to the outer or second optically variable structure (OVD) 18.

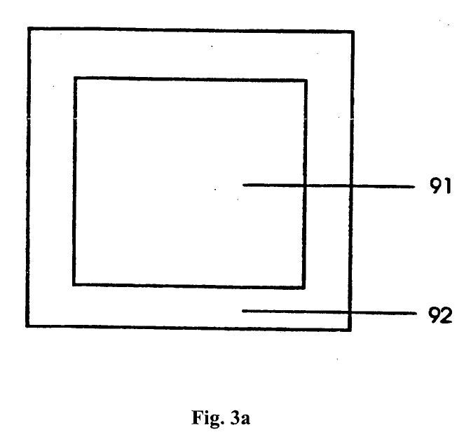

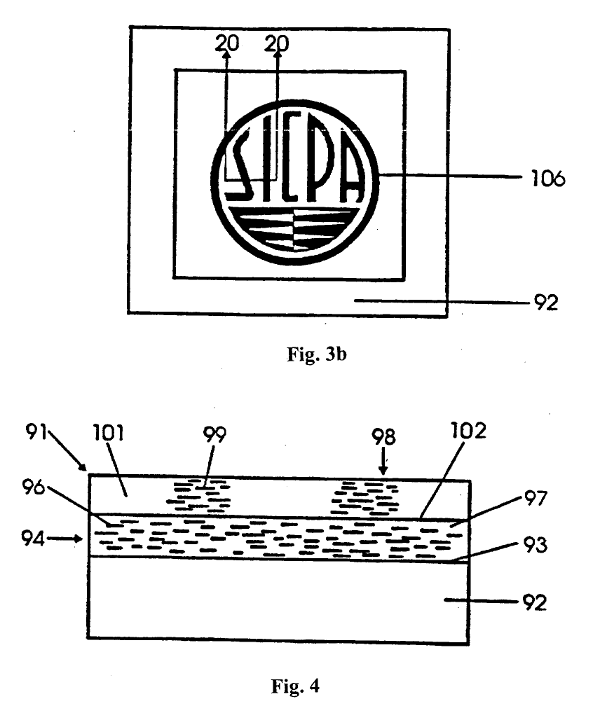

In FIGS. 3a, 3b and 4 there is disclosed another embodiment of a paired optically variable article 91 utilizing paired optically variable pigments. The optically variable article 91 is mounted on a substrate 92 of the type hereinbefore described having a surface 93. An optically variable structure 94 having an optically variable pigment in the form of flakes 96 disposed in a solidified clear vehicle 97 is provided on the surface 93. Another optically variable structure 98 which utilizes an optically variable pigment 99 disposed in a clear solidified toner vehicle 101 is provided on surface 102 of the optically variable structure 94 and provides a symbol or message which for example can be in the form of a logo 106. The symbol or logo 106 disappears at one angle of incidence with the optically variable pigments 96 and 99 having the same color as for example green so that the symbol is masked at normal incidence but appears when the device is tilted to a different angle to cause color shifts to occur as for example a color shift from green to blue with one pigment and green to magenta with the other pigment. Thus by way of example there would appear a green square at normal incidence and at an angle, the symbol 106 would appear in blue on a magenta background as depicted in FIG. 3b.

Features such as the ones shown in FIGS. 1 through 4 can be provided on currency or financial instrument or on other valuable items requiring authentication and which require a user to be able to identify the security feature.

For the past many years, Canadian banknotes have had a simple and relatively effective security region in the form of a thin film interference filter disposed thereon. This filter changes color with change in viewing angle or angle of incident light. Notwithstanding, different filters can be used on different denominations; for example filters which change from gold to green while or alternatively, filters which change from red to blue. Of course over time, as the tools and abilities of counterfeiters become more sophisticated, such simple security and authentication devices lose their effectiveness and they become illegally copied.

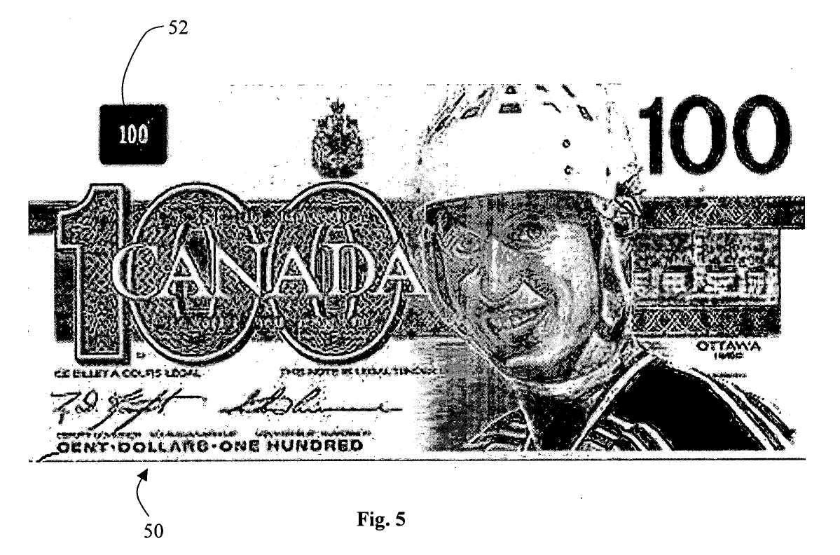

For example, FIG. 5 shows a Canadian one hundred dollar bill 50 having a color shifting label 52 disposed on the upper left side of the bank note with the number 100 at its centre. When the banknote is tilted or the angle of incidence of the light source upon the label 52 is changed the color appears to shift from gold to green.

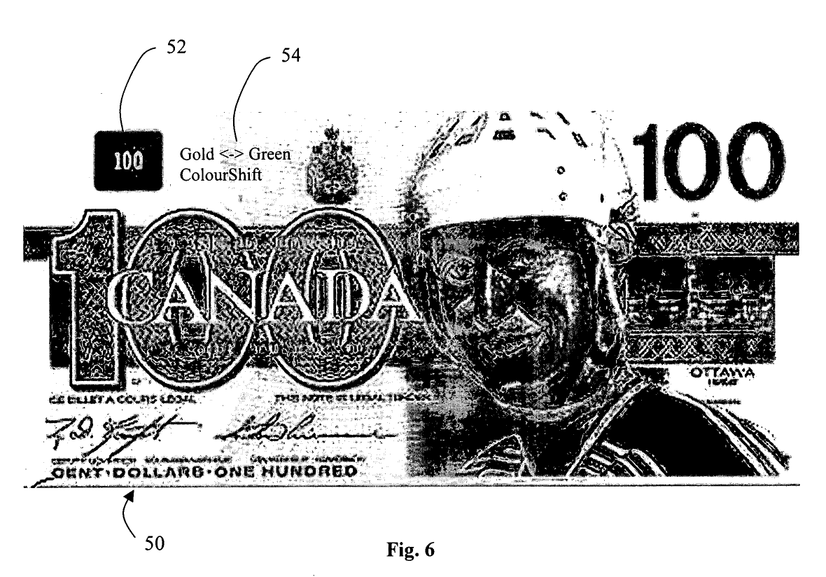

In accordance with this invention, the banknote shown in FIG. 6 shows indicia 54 to the right of the label 52 which describes to the holder of the currency that the security feature is color shifting label which changes color from gold to green, or green to gold.

Ideally universal symbols would be adopted which would be used on currency to indicate particular features.

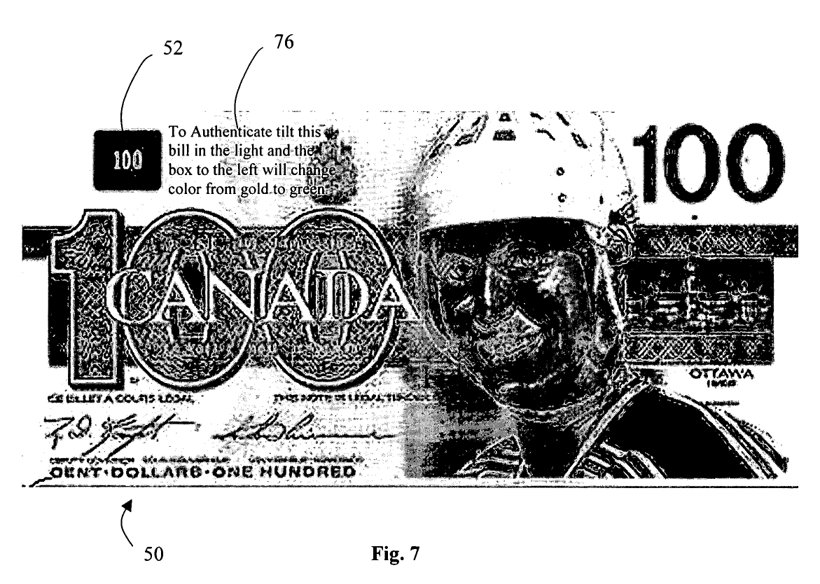

FIG. 7 illustrates an alternative embodiment wherein indicia in the form of more complete instructions 56 are provided on the currency.

Since standard photocopying techniques will not produce a copy of the banknote with a functional color shifting feature, the authenticating indicia or instructions will be copied however the security feature will not properly be copied and the result of following the instructions on the banknote related to the security feature, in accordance with this invention, will indicate to the user that the banknote is counterfeit.

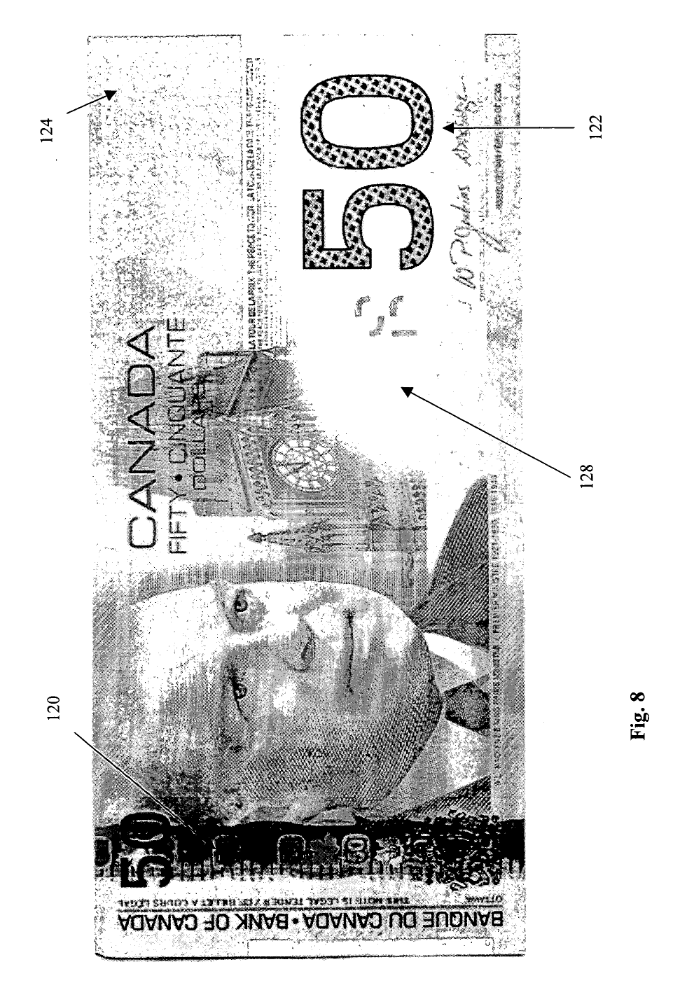

Attempting to be one step ahead of the counterfeiters requires the security features on banknotes become more complex. More recently issued and circulated Canadian banknotes have a plurality of more complex features thereon; for example the 50 dollar banknote shown in FIG. 8 has the following features: a region 124 in the upper right which is embossed in Braille; a numeral 50 in the lower right 122 which has raised small maple leaves within the number fifty; a ghost head within a substantially white region 128 to the left of the embossed numeral fifty; and, a security ribbon 120 which shift color with change of viewing angle and which is a dull gray at one particular angle.

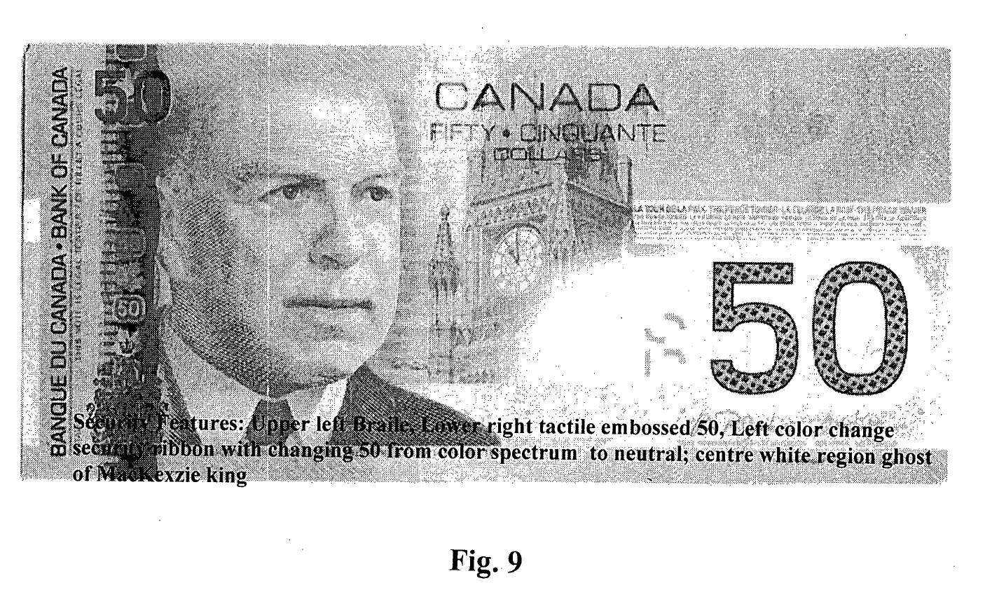

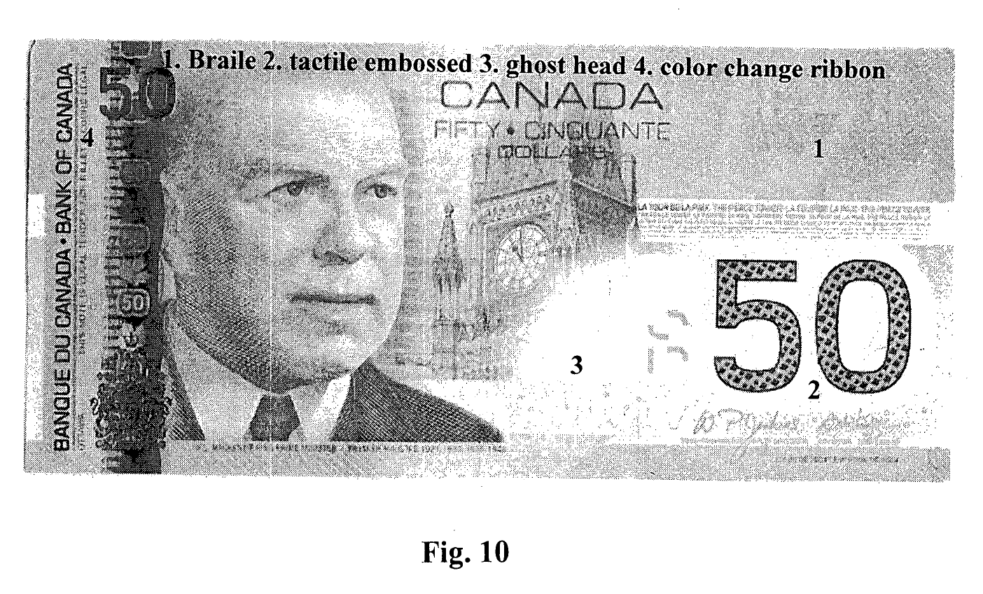

Since most Canadians are not familiar with these features, in accordance with this invention, indicia could be provided on the currency as is shown if FIGS. 9 and 10.

FIG. 9 has the feature printed in English text along the bottom edge of the banknote. Alternatively, reference numerals in the form of a legend can be used, as is shown in FIG. 10. Ideally, the indicia provide the user with information related to the functionality and location of the security feature.

FIG. 10 has a legend along the top and location indicators in the form of numerals indicating the location of the security features depicted by the legend.

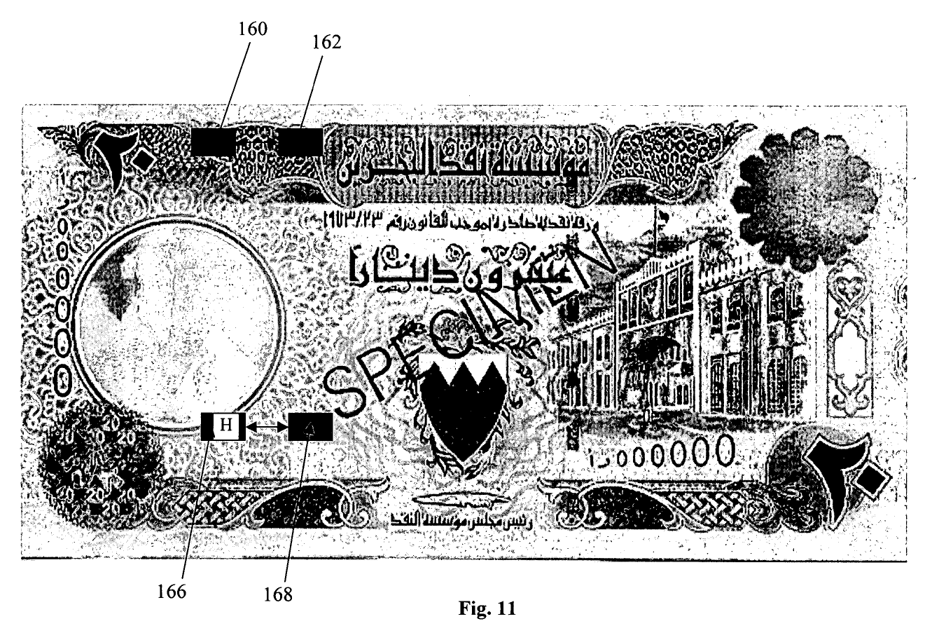

FIG. 11 illustrates another currency in accordance with an embodiment of this invention wherein indicia in the form a brown square 160 and a green square 162 having an arrow therebetween indicates that the surrounding ink has a color shift from brown to green and vice versa with change of incident light or viewing angle. A blue square 166 bearing the letter H with an arrow pointing to and from a magenta box 168 indicates that a color changing hologram is present changing from blue to magenta.

In preferred embodiments of this invention the indicia directing the holder or user of the currency to the functionality and location of the security feature will copy on a standard color photocopier, however the functionality of the feature will not properly copy rendering the security feature useless. This allows the user to use the instructions or indicia to test the feature.

It should be understood that in a preferred embodiment of this invention, one or more symbols are provided which instruct the user or holder as to the function and/or location of a security feature. This has applicability to financial instruments and other articles requiring authentication by way of security devices attached thereto or associated therewith.

What is claimed is:

1. A financial instrument comprising:
a substrate;
a security authenticating device on the substrate, including a visual or tactile security feature; and,
indicia supported by the substrate for indicating the functionality of the visual or tactile feature, wherein the indicia is reproducible by a photographic process.

2. An article as defined in claim 1, wherein the indicia also provides information related to the location of the security-authenticating device.

3. An article as defined in claim 1 wherein the security feature cannot be copied by a photographic process.

4. An article as defined in claim 1, wherein article is a banknote; and wherein the security authenticating device changes color with a change in angle of viewing or a change in incident light thereupon.

5. An article as defined in claim 4 wherein the indicia is in the form of text instructions relating to the color shift property and/or colors in a range of colors that the device changes to.

6. An article as defined in claim 4, wherein the indicia is in the form of one or more symbols in a non-text symbolic language relating to the color shift property and/or colors in a range of colors that the device changes to.

7. An article as defined in claim 1, wherein article is a banknote; and wherein the security device has embossed or raised text, symbols or features that can be authenticated through tactile handling of the instrument.

8. An article as defined in claim 7, wherein the indicia is in the form of text instructions relating to the embossed or raised text, symbols or features.

9. An article as defined in claim 7 wherein the indicia is in the form of non-text symbols relating to the embossed or raised text, symbols or features.

10. An article as defined in claim 1 wherein the article is a banknote and wherein said indicia includes a legend at a first location and related indicia at a plurality of locations near security features, wherein the legend provides information related to the function of one or more security features.

11. A financial instrument comprising:
a substrate;
a security authenticating device on the substrate, including a visual or tactile security feature; and,
indicia supported by the substrate for indicating the functionality of the visual or tactile feature, wherein the indicia is reproducible by a photographic process, wherein said indicia includes a legend at a first location bearing information related to one or more security features and corresponding security feature location indicators at other locations where the one or more security features are present.
